(19) United States
(12) Patent Application Publication
(10) Pub. No.: US 2017/0132575 A1
(43) Pub. Date: May 11, 2017

(54) System and method for obtaining vehicle servicing, repairs and parts pricing.

(71) Applicant: Jason Van Buren, Moreau, NY (US)

(72) Inventor: Jason Van Buren, Moreau, NY (US)

(21) Appl. No.: 14/937,639

(22) Filed: Nov. 10, 2015

(51) Int. Cl. G06Q 10/10; G06Q 30/02; G07C 5/00

(52) U.S. Cl. CPC G06Q 10/1095; G07C 5/006; G06Q 30/0283; G06Q 30/0255

(57) ABSTRACT

In order to obtain multiple pricing for vehicle parts, servicing or repair, a smart phone application is used to transfer specific vehicle data to a website, which allows a plurality of vehicle repair service providers (VRSPs) to review the information, and provide pricing. In at least some embodiments, one or more of the following types of processes are involved. The user retrieves VIN data through scanning, wireless or manually entering. The Vehicle Identification Number (VIN) is transferred to the VRSP. The VRSP can review previous VIN information for that vehicle. The requested selects their preference for date and time of service/repair, and the VRSP must accept this date if making an offer. The VRSP provides a one-time cost response. The requester handles responses via a smart phone application. The smart phone application database maintains all VIN data for that vehicle, for future advertising purposes, and can transfer to new owners.

### CROSS-REFERENCE TO RELATED APPLICATIONS

N/A

### STATEMENT REGARDING FEDERALLY SPONSORED RESEARCH OR DEVELOPMENT

N/A

### REFERENCE TO SEQUENCE LISTING. A TABLE OR A COMPUTER LISTING COMPACT DISC APPENDIX

N/A

### BACKGROUND OF THE INVENTION

The act of acquiring routine maintenance and repairs for various type of automobiles can be a very drawn out task. There are times when the vehicle owner knows exactly what service they need for their automobile, and then, there are times when a repair is needed, and exact diagnosis is unknown.

When searching for a service provider the standard process has been to conduct research of providers through phone book, internet and speaking with other people. This is a time consuming process.

In the United States, all vehicles and light trucks sold after 1996, are required to have on-board diagnostics (OBDII). These diagnostics generate pre-formatted codes that can be used to help define how the vehicle is performing.

There are two types of data generated by the vehicle. There is operational data that is a continuous flow of information, generated as the vehicle is in operation. This would be data such voltage corning from an alternator, or air flow circulation.

Then, there is fault code data. Fault code data could be one major incident that has been predetermined to be out of the proper operational specification. When a major fault is detected the vehicle's performance could drop significantly. A fault code will also notify the vehicle operator by the activating a warning light on the vehicles dashboard. The most common fault code indicator on a vehicle is the check engine light. The fault code generated by the vehicle is predetermined by the manufacturer, and can be any type mix between numbers and letters.

The standard process for vehicle repair and service providers (VRSPs) to read these fault codes by connecting the OBDII to the vehicle either through a hard line, or wirelessly. Once the fault code has been read by the VRSPs, they can determine either what to fix, or where to begin their diagnostic review of the vehicle.

With the improvements in technology and smart phone applications, there are now many different types of devices that can read the OBDII fault codes. Vehicles operators can now purchase these OBDII fault code indicators for personal use. The vehicle operator can now read these codes and is able to make a decision to continue diagnosing on their own, bring the vehicle to a VRSP, or reset the fault code, turning off the “check engine” light, and see if the issue comes back again.

The fault code can be the foundation of how the VRSP estimates the problem with the vehicle. In many cases, the VRSPs can estimate the amount of labor and parts that are needed to repair a vehicle, based on reviewing the fault codes. At a minimum, the VRSP has enough information to begin further diagnosis, with a much more focused review on a section of the vehicle that appears to be having the issue.

The traditional approach of locating a VRSP to provide services, repairs and parts has been through the use of phone books, internet searches or word-of-mouth from acquaintances. This approach fails short of providing the full details of the VRSP to make a more knowledgeable decision.

The vehicle owner would get much more value out of the search for a VRSP if they had better information, to make a more knowledgeable decision. More beneficial information in this process would be having stored data of all of their vehicle components, actual VRSP user performance evaluations, VRSP name, location and contact information, up-front pricing costs, confirmed appointment times, automatic calendar updates and the ability to conduct payment processing ahead of time.

### SUMMARY

This patent application includes all submitted, and referenced documents included, as well as detailed disclosures of the process.

The concept in this application is a process by which the individual scans their vehicle identification number (VIN) to load specific vehicle information into their smart phone. The user will then have the option of requesting service, repairs or parts through a smart phone application (app). The app will then transmit ail service requests, OBDII and vehicle data to a website, where VRSPs can review the individual requests. The website will allow the VRSPs to either automatically use their predefined set rates to issue a cost for completion, and/or offer to conduct diagnostic testing. The user then receives a notification from the app, and can go review the VRSPs full response. The user can choose to accept or deny the VRSPs responses. Once the user accepts the VRSP quote, the app will handle the payment, and issue a digital certificate to the user. The app will also schedule an appointment on the user's phone with all necessary data. The user then just needs to arrive at the VRSP's location and have the service completed, or receive the parts. All data related to that VIN will be stored for future use related to advertising and to provide a historical view of the vehicle.

In the case of requesting maintenance services alone, the requester will know exactly what they are asking for and able to select that option from the app. Some examples of services are general maintenance items such as and oil change, inspection or tire rotation.

The requester can also select repair options that will allow them to choose from pre-determined OBDII codes. These OBDII codes will need to be retrieved from the vehicles system. This can be done either by the user, utilizing our OBDII plug in device, one of the many type of household or smart phone apps, or by taking the vehicle to a service location to have the OBDII codes read. The user can also opt to use the smart phone app to connect wirelessly to receive OBDII fault codes from the vehicle.

The requester can also select to purchase parts from the smart phone app. The app already has all of the vehicles information stored, which was done during the initial VIN scan. When purchasing parts, the requester will receive parts options faster because the app already knows the vehicles specs, and will only show parts options that fit that vehicle.

The requester may also select a combination of options between maintenance service and repairs. For example, the requester may select to have an alternator replaced, while also getting the vehicles oil changed.

The VRSPs will utilize a website to register, list their company information, pricing, and either monitor for requests to provide pricing, or submit standing rates. Standard information that the VRSP will provide is business name, business address, hours of operation, contact phone, billing account data for payment, hourly labor rate, diagnostic rate, rate by specific jobs such as an of change. The VRSP also has the ability to pm-select repair costs for one, or all OBDII codes.

Once the VRSP is registered on the website, they can select to receive alerts notifying them of new service requests available, or, the VRSP has the option to have their pricing information sent out automatically. When reviewing the request, the VRSP cannot see any other company's information, it is important to note that this process is not a reverse auction in anyway, nor can the VRSPs see any other pricing or competitor information. A major focus of this app is to locate quality VRSPs where lowest cost may not be the most important qualifier.

In some instance the requester will provide a service request where the exact repair requirement is not known. In these cases, the VRSP has the option of providing a “diagnostic” fee. The diagnostic fee is provided during the quoting process. The intent of the diagnostic fee is to notify the requester that further review of the vehicle is necessary to determine exactly what is required to repair the vehicle.

The requester is notified of new VRSP submission replies through the app notification process. The app notification process must be turned on to be used. If the app notification is not turned on, the user would need to manually log into the app to view all service request replies from the VRSP.

When viewing the VRSP replies the user will have the ability to see most relevant information such as; VRSP name, address. phone number, parts cost, labor cost, any request service cost and feedback rating.

The requester will have the choice of doing nothing, denying the VRSP reply, or accepting one of the VRSP offer. If the requester denies the reply, the VRSP offer will be closed for that particular service request, and the VRSP Will receive an email notifying them. If the requester ignores the VRSP reply, the offer will remain in a valid mode until the requester accepts the request, or ten days go by. After ten days, if no action is taken by the requester, the service request will close. The ten day limit may change. The intent is to show that the request does not last indefinitely and will expire if no action is taken.

If the requester accepts a VRSP offer, all other offers will be closed. The requester will then go to the next step in the app. The next steps will consist of verifying the appointment date/time, and will ask the user to pay for the service request. Once the service request has been paid for, the app will schedule an appointment on the requester's smart phone, within the calendar section, thus creating an appointment that can be setup for reminders. The calendar appointment in the app will include all details of the VRSP. The funds paid by the requester will then go to a holding account, until the service is complete.

The app will also generate a certificate, stored in the app, or available to print. When the requester arrives at the VRSP to have the service performed, they will be requested to show this certificate. The VRSP will either scan the certificate, or type in the barcode to confirm that the work has been done.

The confirmation of this barcode from the VRSP will generate the payment. The payment will go from the holding account to the VRSP account.

After the service is completed, the requester will receive an app notification to enter feedback on the VRSP. The user will have the option to either complete the feedback, or decline.

The website will also store a vehicle service, repair and parts ordered on a database. The intent of this database is to create a timeline and complete history of each specific vehicle, and all service, repairs and parts that were ever processed through the application.

The historical information and specific VIN number will allow the smart phone application to conduct targeted advertising campaigns. The intent is to use the VIN number and vehicle data to make specific advertising offers based on historical services using previously stored service, parts and repair information.

All data related to the VIN number can be transferred to the new vehicle owner should the user sell the automobile. This will allow the next user to view a historical review of the vehicles maintenance log and known repairs.

### DRAWINGS

FIG. 1a provides an overview of how the smart phone app receives the vehicle identification number (VIN). FIGS. 200a, 200b, 200c and 200d are the four types of inputs that the app will receive, providing the VIN. The smart phone app will then transmit the VIN data to a website 201 that allows application programming interface (API) requests. These requests will take the VIN number, and provide back to the smart phone app, all of the corresponding specific vehicle data 202, that was included from the factory.

FIG. 1b provides a block diagram overview of how the requester can generate a service request. 203a, 203b 203c, 203d, 203e are each examples of scenarios which would generate a service request 204 from the smart phone app to the VRSPs. When the service request is generated all of the vehicles information, previously stored by scanning the VIN number, is sent to the VRSP 205.

FIG. 1c provides an overview of what the VRSP can view, and how they reply to a service request. When the VRSP registers as a service provider 206, they have the option to be very specific about which types of service requests they would like to receive notifications for, or view on the website. The intent of this feature is to allow the VRSP to select types of repairs, or services, where they are more specialized, and to block out any types of service, or repairs which that shop does not perform. The VRSP can focus only on certain vehicle types, specific maintenance, repair or parts. The VRSP will receive a smart phone notification, email or text 207 notifying them of the pre-selected opportunities available. The VRSP can choose to not filter out results, and view all service requests that fall within their geographic area. When reviewing service requests the VRSP has the option to review historical vehicle data related to that VIN 208. After reviewing all of the data from the service request, the VRSP enters their labor and parts cost, or a fiat rate fee for the service, such as an oil change 209. If the requester entered a required date/time of the service to be performed, the VRSP must also commit to that requirement. The VRSP can enter this data either on the website, or within the smart phone application 210.

FIG. 1d provides an overview of what happens once the VRSP replies to a service request with a new quote. The requester will receive a smart phone notification 211. The requester must then log into the smart phone app to view the response. Once logged into the app 212, the user can view all responses to their request. The requester can choose to approve, deny or do nothing 213 with the VRSP response. If the user rejects the VRSP quote 214, they will be ineligible to provide any further information, and will be removed from the requesters list of available responses. (This further drives the point that this is a fiat rate fee service, not a low bidding strategy app). If the requester decides to approve the VRSP response 215, these actions will happen. First, the VRSP will receive a smart phone notification notifying them that they were selected for this service request. The website service request will be closed out so that no other responses can be made. The user then pays for the service on their smart phone and a certificate is created. The certificate is accessible through the application and also visible by the VRSP on their account via the website. The smart phone app will then create a calendar appointment on the requester's phone, and also on the VRSP's calendar account via the website.

FIG. 1e provides an overview of what happens when the requester arrives at the VRSP to have the work performed. On the scheduled days of service 216, the requester arrives at the VRSP for the service to be performed. The requester will present their printed certificate, or show their smart phone, to the VRSP provider indicating they have pre-paid for the service and have a scheduled appointment 217. Once the service is completed the requester will submit the “service completed” option on the smart phone 218. Once the app receives the completed service notification, payment will be generated to the VRSP's account 219. The requester will receive a notification asking them to complete a feedback survey on the VRSP and the service experience 220. The master database will be updated with the service completed, and will be tied to that the VIN of that particular vehicle 221.

FIG. 1f provides an overview of what the requester will see on their smart phone when going through responses from VRSPs. Please, note this is not an exact replica of the smart phone screen, but provides a general illustration of the data. The user will see the full business name and address details 222. The user will also see the distance 223 between the requester's zip code on file, or current location, if the global positioning feature (GPS) on their smart phone is turned on, and they select that option. The requester will have the ability to see a feedback score of the business 224, based on previous feedback from other customers. The user will also see an overview of the cost of the total service requested 225. The user can then have the option to select multiple request requested to deny, or one to accept 226.

FIG. 1g provides an illustrated overview of how the requester will initially register their vehicle. The user can select the option to have the VIN retrieved via Bluetooth 227. The request can also scan their VIN barcode from the windshield or other vehicle documentation 228. The user can connect an OBDII device to their vehicle and transfer the VIN data 229. The user can also manually enter the VIN into the smart phone app 230.

FIG. 1h shows a visual illustration of what the VRSP will see on the website. The VRSP will be able to see the vehicle year 231, make 232, model 233, trim 234 and VIN 235. The VRSP can also see the requester's user ID 236 from the smart phone application. The VRSP will see a complete list of the services requested and repair codes related to the vehicle 237. The next area 238 provides a definition of each service, or the OBDII fault code. The next area 239, is where the VRSP must enter their pricing information on each line. The VRSP will have the option to provide a diagnosis fee, in which the vehicle will be inspected to provide full details of the repairs needed for that particular problem. The user will have the option to enter their specific date and time request for the service to be completed 240. The last column will be the total price of the service and repairs 241.

FIG. 1i: This flow chart drawing provides a complete walkthrough of the process. 242 shows where the user will download the smart phone application and begin the process of collecting the VIN for the vehicle. 243 shows how the VRSP will register their business via the website, and what information they are required to provide 244 is the first step in the process that begins with the user making a request for parts, service or repair. Each next step in the process can be followed by going in the direction of the arrows. The “accepting offer” triangle is a decision point where the user decides whether or not to accept an offer from a VRSP 245.

### DESCRIPTION

Figures and enclosed embodiments are not limiting.

The term “service” or “service request” should be synonymous with a service, repair or parts request. The term service is used to explain the request process of any of these three types of application functions.

Embodiments are illustrated in referenced figures of the drawings. It is intended that the embodiments and figures disclosed herein are to be considered illustrative and not restrictive. No limitation on the scope of the technology and of the claims that follow is to be imputed to the examples shown in the drawings and discussed herein. It should also be understood that any feature of one embodiment disclosed herein can be combined with one or more features of any other.

The term “real-time” is intended to mean as soon as the combine features of the process complete their actions. The term means an activity that occurs with no delay human delay, but may have a short delay is the system (computer, wireless) processes face a delay or lag period of seconds or minutes.

The concepts enclosed herein contain several different embodiments. The intent of this smart phone app is for individuals, whether private, commercial business or other, to utilize the advantages of a combination of technology to ultimately purchase vehicle parts, request routine service or repair. Vehicle information is initially collected through a scan of the VIN barcode, or manually entering the information. All vehicle data is then stored locally and is used to provide specific data to the VRSP. When a service request, is made to the VRSP, it of this data will be transmitted so that the VRSP has the specifications of the vehicle. The requester will also include the OBDII codes if submitting requests for repair on the vehicle. The request will go to a website and provide notifications to a plurality of VRSPs, who can choose to reply to the service request. The VRSPs can then reply to the service/repair request and will be asked to list the parts and labor costs associated with a repair. If replying to a service request, or parts request, the pricing will be flat rate. The intent of this process is a fiat rate fee, where VRSPs get one chance to provide their rates. VRSPs can opt to pre-define set rates, so service requests are automatically replied to, or they can manually check each service request and make a manually entry. The requester can then make a decision on which VRSPs offer to accept, or decide to decline all. Further embodiments of this process are included.

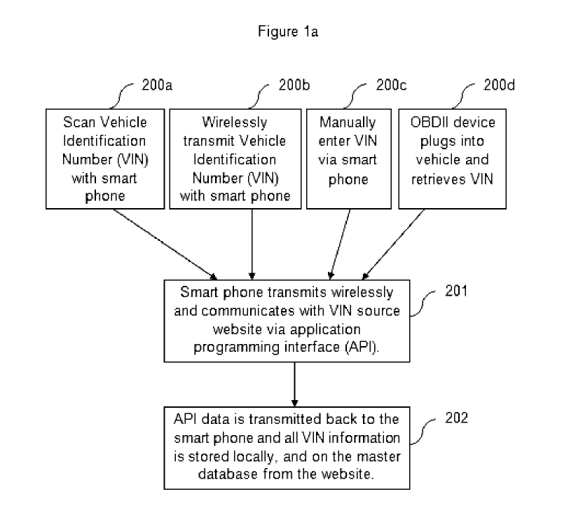

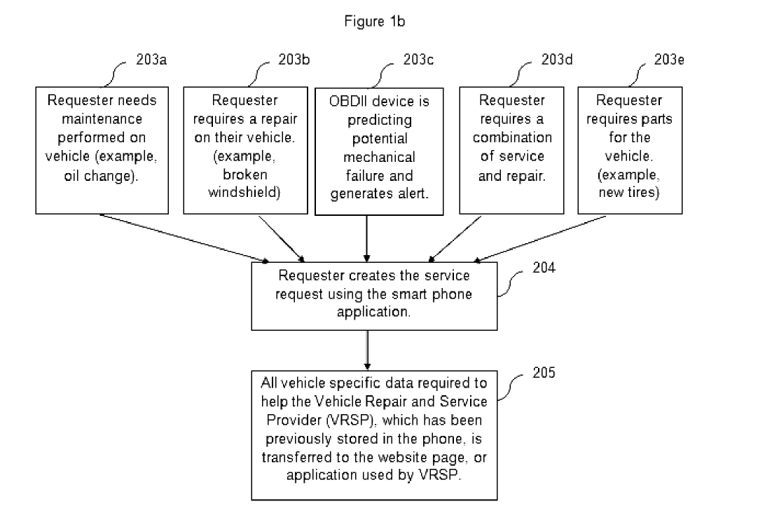

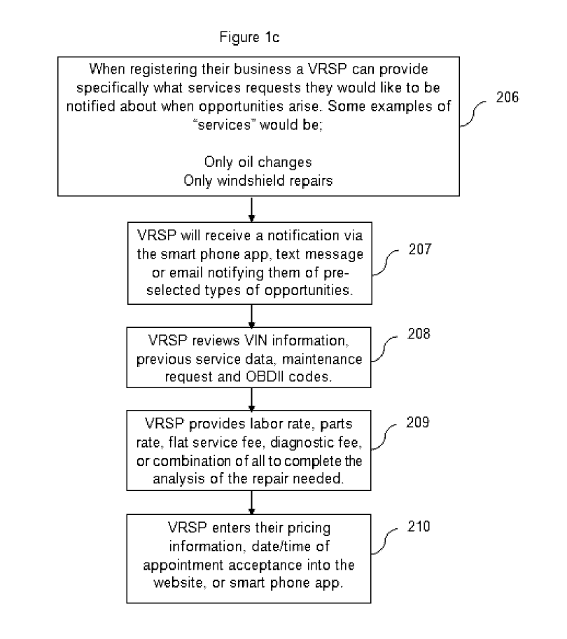

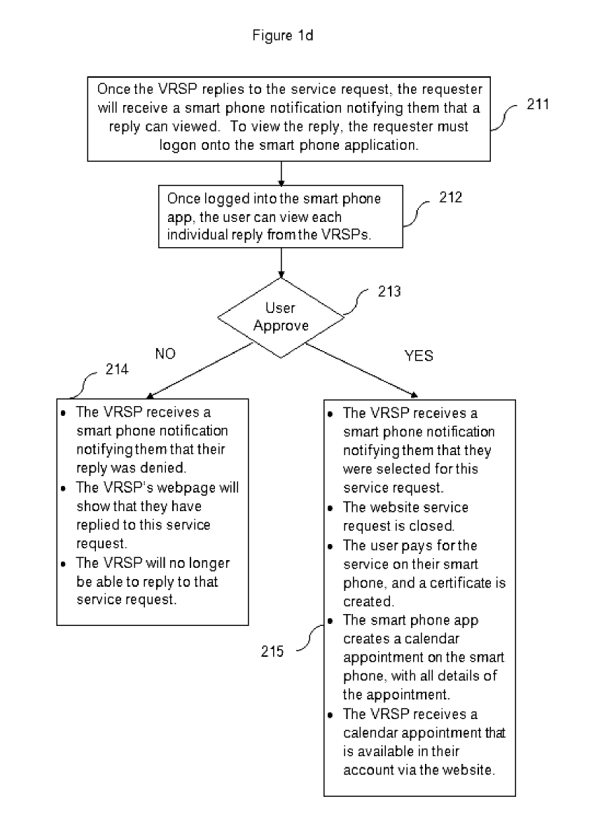

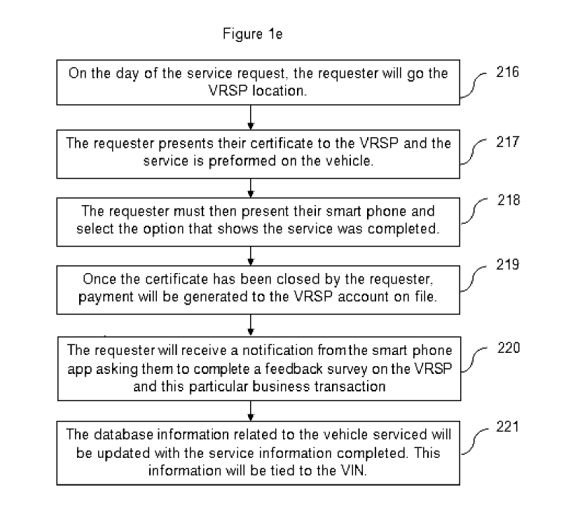

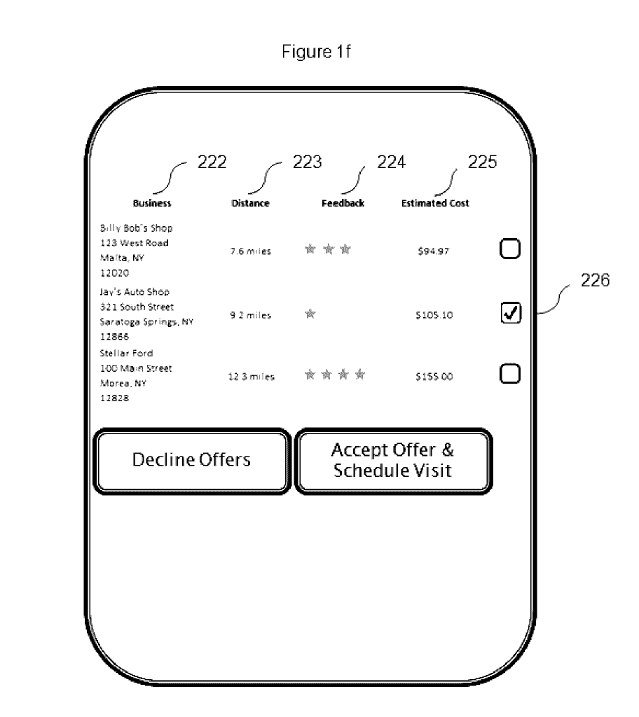

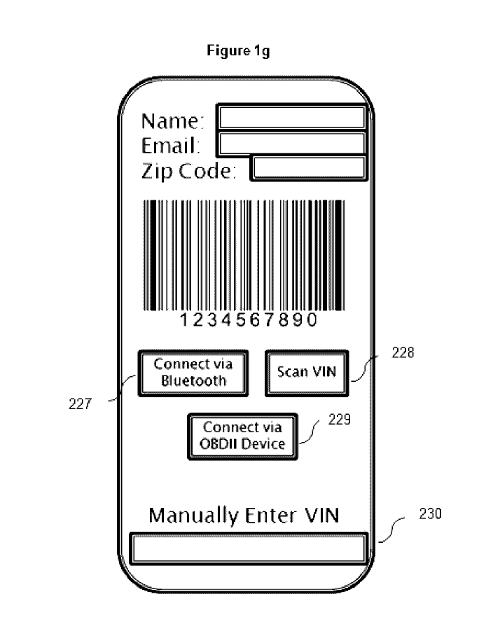

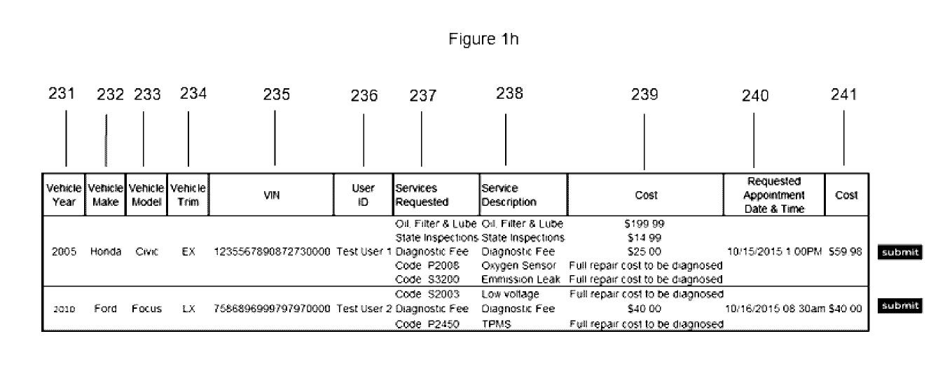

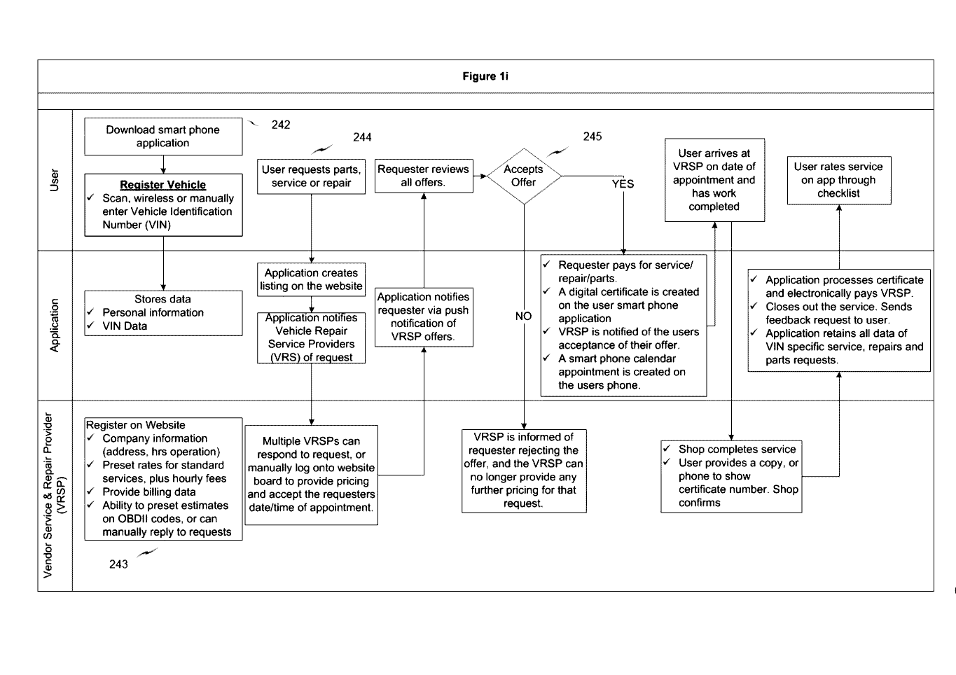

FIG. 1a diagram provides an overview of how the requester obtains their vehicle data. The vehicle data can be transmitted via Bluetooth from the vehicle to the phone, or the user can scan the VIN barcode manually enter it, or use an OBDII connection cord direct from the phone. All four of these options will retrieve the vehicle data related to the VIN. The smart phone application will then transmit the VIN data wireless and communicates with the VIN source website via application programming interface (API). API data is transmitted back to the smart phone and all VIN information is stored locally, and on the master database from the website. The intent here is that all VIN data will be maintained, and that all future parts, service and repair requests will be tied to this VIN number, which can be transferred with the vehicle if sold.

The first type of request that can be made is for a service. A service intended to be the type of work that is general maintenance or replacement of items on a vehicle. Some examples of a service request would be an oil/fluid change, tire replacement or periodic checkup based on vehicle mileage. The second type of request would be a repair. A repair is a much broader scope of potential work and could be from any area of the vehicle. The use of OBDII codes in this process help to provide the VRSP where to begin the diagnosis of the repair needed. It is important to note that when requesting a repair, the user may not have specific instructions on the repair. The user can provide the OBDII codes, or a description of the problems they are seeing to help the VRSP with their diagnosis. The third type of request is generated through the use of the OBDII device, This device monitors the vehicles systems and will generate a warning to the user when one of the system components is out of specification. The user can then decide to take this warning and make a service/repair request. The fourth type of request is when the user requires both a service, and a repair request. The fifth type of request is when the user requests parts for their vehicle. In this example, the requester can put a request out to the website.

It is important to note that when making any type of request, all of the vehicles specific data tied to the MN is used to filter down potential VRSP. This function can also be used by the VRSPs to only search for vehicles that match certain criteria. This feature is used to ensure that only relevant responses, specific to the vehicle will return in any request reply.

The user will also have the option to enter the date and time of the service request.

All VRSPs must register when initially joining the website. The VRSP will be required to enter all information relevant to their business. All primary information such as business name, location, hours of operation and billing data will be required to be input. The VRSP will then have the ability to set pre-defined prices for each of their services. The purpose of this is so that when then requester makes a service/repair/parts request, the pricing will automatically reply to the requester with a response. The VRSP can choose to leave all pricing data blank, and simply review the website board and make manual entries. Once the VRSP account is setup, the VRSP will receive a notification via the smart phone app, text message or email notifying them of the pre-selected opportunities. Based on how the account was setup by the VRSP, the responses will go back to the requester either manually or automatically. Both automatic and manual entries are considered responses to the requests and will go back to the requester as a reply.

While reviewing the service/repair request, the VRSP has access to view all of the vehicle information related to the VIN. The VRSP will also have the ability to view some of the previous service data, other maintenance requests and OBDII codes. The intent of this aspect is to allow the VRSP to potentially get a better understanding of the overall vehicle's history to help with any potential diagnosis.

The VRSP reply will include all, or a mix of the labor rate, parts price, flat service fee or a diagnosis fee in their response. Not all repairs can be diagnosed through the use of this app. Therefore, the option of a diagnosis fee exists, so that the requester has a fiat rate price for a repair quote given ahead of time. The VRSP win also need to confirm if the date and time selected by the user is available. if the date and time is not available by the VRSP, they will not be able to reply to the user's request. The VRSPs webpage will show that they have responded to this service request, thus not allowing them to submit any further offers.

When making a manual response to the request, the VRSP can choose to do this through the website, or on their smart phone app. Automatic replies do not require the VRSP to log into the system.

Once the VRSP replies to the service request, the requester will receive a smart phone notification notifying them that a reply can be viewed. The user will have had to have previously setup their notification preferences. To view the full reply details, the requester must log into the smart phone application. Once logged into the smart phone application the user can view all of the VRSP responses. The requester will then have the ability to view a response. A response (FIG. 1f) will include the shop name and address, distance from the requester, total feedback score and price.

The requester will have the ability to deny multiple responses at once, but can only accept one offer. If the requester denies a VRSP's response, that particular service provider will receive a notification telling them their offer was denied. That particular service request will no longer be available to that VRSP for any further responses.

If the requester decides to accept an offer, multiple items will happen. First, the website will show that this particular service request has been closed and no further VRSP responses will be allowed. Secondly, one the user accepts the request, they will have to immediately pay for the service. The payment can be in the form of all standard types of electronic transactions such as credit cards and other third party banking services. Once the service has been paid for, the user will have a certification created on their smart phone which must be kept to be shown to the VRSP on the day of the appointment. The certificate only applies to service and repair requests. Any parts requests will not require a certificate, as parts will ship from a VRSP to the requesters address. Next, the application will create a smart phone calendar appointment, and based on user's settings, will provide reminders as the date approaches. The application will also create an appointment on the VRSPs website calendar showing them when this requester will be onsite for their appointment. The VRSP will also have the option of multiple settings with this calendar. Once the service is paid for, both the user and VRSP will receive notifications providing them all of the contact details of both parties. These contact details will be part of the application.

On the day of the service/repair appointment, the requester will go to the VRSP and present their phone certificate. At this time the user only present the certificate to the VRSP. The VRSP will then perform the service/repair.

I the service request included a diagnosis fee, then the entire service has not yet been paid for, and additional work may be required. In this instance, the VRSP will be required to perform the diagnosis and inform the requester of the estimated fees to the repair the problem. The requester has the option to continue or deny this request. In the case of the requester approving the additional charges, no additional billing will be required from the smart phone application. Any further work performed would be a requester to VRSP transaction, outside of the smart phone application process.

Once the original service request has been completed the user will need to mark the certificate as being fulfilled. This will close out the open service request with the VRSP, and generate a real-time payment transaction. The requester will need to show the VRSP that the certificate has been dosed. Once this has been completed the VRSP has completed their service requirements.

Shortly after the service has been completed the requester will receive notification, or they can manually access the smart phone application, to provide feedback on the VRSP. The feedback will be mix of questions related to the overall satisfaction of the service request transaction.

All service, repair and part information related to the VIN will be stored in a database, and will remain tied to that vehicle in the system. All of this information is therefore transferable to the next owner, or available to view from the current owner or a VRSP.

The smart phone application will also pull data related to this VIN number from other sites, and maintain the information with this particular VIN. Other stored information may include, but is not limited to, repairs, damages, police reports, sold dates, and other potential data related to that VIN.

1. A method for obtaining service, repairs or parts for a specific vehicle, comprising the steps of;
a) Collecting the VIN information via API from a source website and storing data for that specific vehicle.
b) For repairs, comprising the steps manually entering the OBDII code performance, using a wireless Bluetooth signal, or using a direct vehicle plug-in device.
c) For services, manually entering the services requested and transmitting to a website.
d) For parts, transmitting the VIN data and specific parts request to the website.
e) In response to the service, repair or parts request, the VRSP can either manually enter their prices, or have a pre-determined value sent back to the requester.
f) The step of providing a price back to requester involves accepting the calendar date and time that the requester has asked for.
g) The step of the Smartphone application creating a calendar appointment for the service or repair data.
h) Retaining all specific vehicle repairs, services and parts data based on the VIN.

2. The method of claim 1, wherein the step of conveying the information about the service, repair or pals transmits to a website, where a plurality of VRSPs can make a one-time entry of their total costs for the service.

3. The system of claim 1, wherein the instructions cause the processor to carry out a direct one-time cost entry from the VRSP for servicing the vehicle based on the request, wherein the VRSP enters the total labor, parts and/or diagnosis cost.

4. A method of conducting direct advertising campaigns using the historical VIN service, parts and repair data.

5. A method of transferring ail service, repairs and parts orders, from one owner to the next, based on the VIN data.
